(19) United States
(12) Patent Application Publication
(10) Pub. No.: US 2025/0363685 A1
(43) Pub. Date: Nov. 27, 2025

(54) STORAGE MEDIUM STORING IMAGE GENERATION PROGRAM, METHOD, AND DEVICE

(71) Applicant: Fujitsu Limited, Kawasaki-shi,Kanagawa (JP)

(72) Inventors: Yuma ICHIKAWA, Kawasaki (JP); Nobuo NAMURA, Miyamae (JP)

(73) Assignee: Fujitsu Limited, Kawasaki-shi,Kanagawa (JP)

(21) Appl. No.: 19/188,213

(22) Filed: Apr. 24, 2025

(30) Foreign Application Priority Data
May 23, 2024 (JP) 2024-084320

(51) Int. Cl. G06T 11/20

(52) U.S. Cl. CPC G06T 11/206

(57) ABSTRACT

An image generation device includes a processor that executes a procedure. The procedure includes: generating a multi-dimensional first image representing a frequency characteristic at each time of each piece of time-series data, based on each piece of multi-dimensional time-series data; and generating a single second image obtained by combining the multi-dimensional first images weighted using a random matrix in which a different value is assigned for each frequency.

### CROSS-REFERENCE TO RELATED APPLICATION

This application is based upon and claims the benefit of priority of the prior Japanese Patent Application No. 2024-084320, filed on May 23, 2024, the entire contents of which are incorporated herein by reference.

### FIELD

The embodiments discussed herein are related to a storage medium storing an image generation program, an image generation method, and an image generation device.

### BACKGROUND

For example, a machine learning model is used in an abnormality detection system that monitors time-series data such as an operating state of equipment and biological information of a human and finds an abnormality of a target at an early stage. This machine learning model needs to be trained for each case of abnormality detection, and in particular, when deep learning is used as the machine learning model, an enormous training time is required.

A method of detecting an abnormality of image data by using a trained image classifier which is a base model without training a deep learning model for each case has been proposed. Therefore, in order to apply an abnormality detection method using the base model to the abnormality detection of the time-series data, a method of imaging the time-series data has been proposed.

For example, there has been proposed a method of handling multi-dimensional time-series data by individually performing imaging on time-series data of each dimension using wavelet transform, the Gramian angular field, or the like, and arranging images of the obtained dimensions into one image.

In addition, for example, a signal processing method of performing wavelet transform of a large number of signals in order to determine a desired parameter such as a physiological parameter has been proposed. In the method, first and second signals are received, continuous wavelet transform is performed on the first and second signals, and first and second scalograms are created based on first and second transformed signals. Also in the method, a scalogram mask is created based on the first and second scalograms, the first and second scalograms are filtered with the scalogram mask, and physiological parameters are determined based on the filtered scalograms.

### Related Patent Documents

US 2010/0014723 A

### Related Non-Patent Documents

Biegel, T., Helm, P., Jourdan, N. et al., “SSMSPC: self-supervised multivariate statistical in-process control in discrete manufacturing processes,” Journal of Intelligent Manufacturing, 2003.
Li L., Li Q., Yong W., Zhang S., Yang M., Jiang P., “Intelligent Online Inspection of the Paste Quality of Prebaked Carbon Anodes Using an Anomaly Detection Algorithm. Systems,” 2023; 11 (9): 484.

### SUMMARY

According to an aspect of the embodiments, a non-transitory recording medium storing a program that causes a computer to execute image generation processing comprising: generating a multi-dimensional first image representing a frequency characteristic at each time of each piece of time-series data, based on each piece of multi-dimensional time-series data; and generating a single second image obtained by combining the multi-dimensional first images weighted using a random matrix in which a different value is assigned for each frequency.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an abnormality appearing as a change in a correlation relationship between a plurality of dimensions;

FIG. 2 is a diagram illustrating an example in which it is not possible to detect an abnormality when a first principal component is selected;

FIG. 3 is a diagram schematically illustrating image generation in a first embodiment;

FIG. 4 is a functional block diagram of an abnormality detection system according to first and third embodiments;

FIG. 5 is a diagram illustrating generation of n scalogram images;

FIG. 6 is a diagram illustrating generation of a random matrix;

FIG. 7 is a diagram illustrating an effect of using the random matrix;

FIG. 8 is a diagram illustrating generation of a single RGB image;

FIG. 9 is a block diagram illustrating a schematic configuration of a computer functioning as an image generation device;

FIG. 10 is a flowchart illustrating an example of image generation processing according to the first embodiment;

FIG. 11 is a flowchart illustrating an example of abnormality detection processing;

FIG. 12 is a functional block diagram of an abnormality detection system according to a second embodiment;

FIG. 13 is a detailed functional block diagram of an AE training unit;

FIG. 14 is a flowchart illustrating an example of AE training processing;

FIG. 15 is a flowchart illustrating an example of image generation processing according to the second embodiment; and

FIG. 16 is a flowchart illustrating an example of image generation processing according to the third embodiment.

### DESCRIPTION OF EMBODIMENTS

Hereinafter, an example of an embodiment according to the disclosed technique will be described with reference to the drawings.

First, before describing the details of each embodiment, the necessity of generating an image allowing detecting an abnormality appearing as a change in a correlation relationship between a plurality of dimensions when an image is generated from multi-dimensional time-series data will be described.

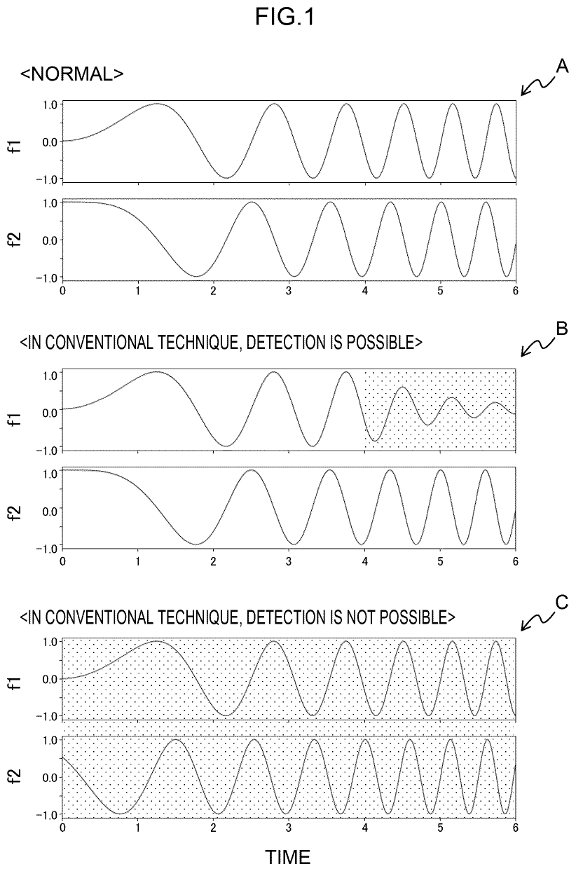

A of FIG. 1 illustrates an example of time-series data f1 and f2 at the normal time. As illustrated in B of FIG. 1, it is assumed that a portion (shaded portion) different from that at the normal time is generated in the time-series data f1. In this case, it is possible to detect an occurrence of an abnormality also in the conventional technique. However, as illustrated in C of FIG. 1, each piece of the time-series data f1 and f2 is not greatly different from that at the normal time, but in a case where a correlation relationship between the time-series data f1 and f2 is viewed, the correlation relationship is different from the correlation relationship at the normal time, and it is a situation in which it is desired to detect the time-series data f1 and f2 as an abnormality. In the conventional technique, it is not possible to detect such a situation.

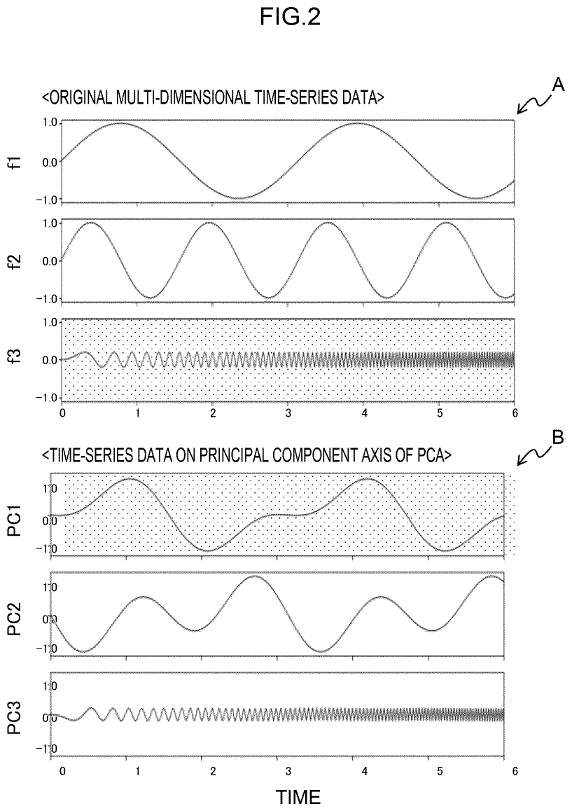

In addition, for example, there is a technique of compressing multi-dimensional time-series data into one-dimensional time-series data, such as principal component analysis (PCA) and auto encoder (self-encoder, AE: autoencoder). Therefore, it is also conceivable to compress multi-dimensional time-series data into one-dimensional time-series data by PCA, AE, or the like, and then apply imaging using wavelet transform, a Gramian angular field, or the like. For example, time-series data f1, f2, and f3 as illustrated in A of FIG. 2 are subjected to principal component analysis, and converted into time-series data PC1 of a first principal component, time-series data PC2 of a second principal component, and time-series data PC3 of a third principal component, as illustrated in B of FIG. 2. It is assumed that the time-series data PC1 of the first principal component is imaged. In this case, even if a change indicating an abnormality occurs in the time-series data f3, it is not possible to detect the change.

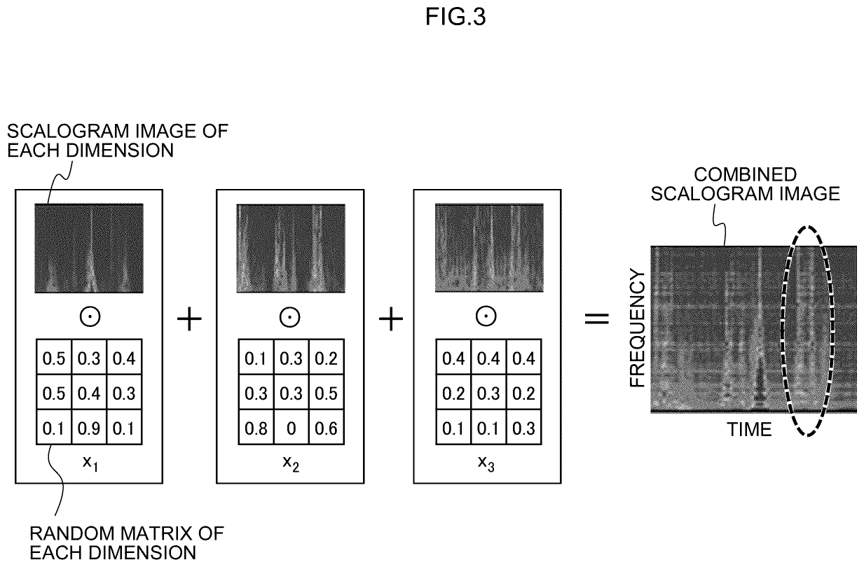

Therefore, in each of the following embodiments, when an image is generated from multi-dimensional time-series data, an image allowing detecting an abnormality appearing as a change in a correlation relationship between a plurality of dimensions is generated. In a first embodiment, the wavelet transform is applied to n-dimensional time-series data to generate n scalogram images. As illustrated in FIG. 3, n (three in the example of FIG. 3) scalogram images are linearly combined by using a random matrix to generate a combined scalogram image that is a single image. The random matrix illustrated in FIG. 3 is simply expressed, and is actually a matrix having the same pixel size as the scalogram image.

Since the scalogram is sparse and takes a value close to 0 in most regions (pixels), original information is unlikely to be damaged even if linear combination using the random matrix is performed. By using different weights in a frequency direction, it is possible to ascertain the correlation relationship between dimensions in various combinations. For example, a stripe pattern (an elliptical portion of a broken line) in the longitudinal direction (frequency direction) viewed in the combined scalogram image illustrated in FIG. 3 represents a correlation relationship between dimensions.

In a second embodiment, a machine learning model such as a neural network that compresses a plurality of images into one image is used instead of the random matrix in the first embodiment. Each embodiment will be described below in detail.

### First Embodiment

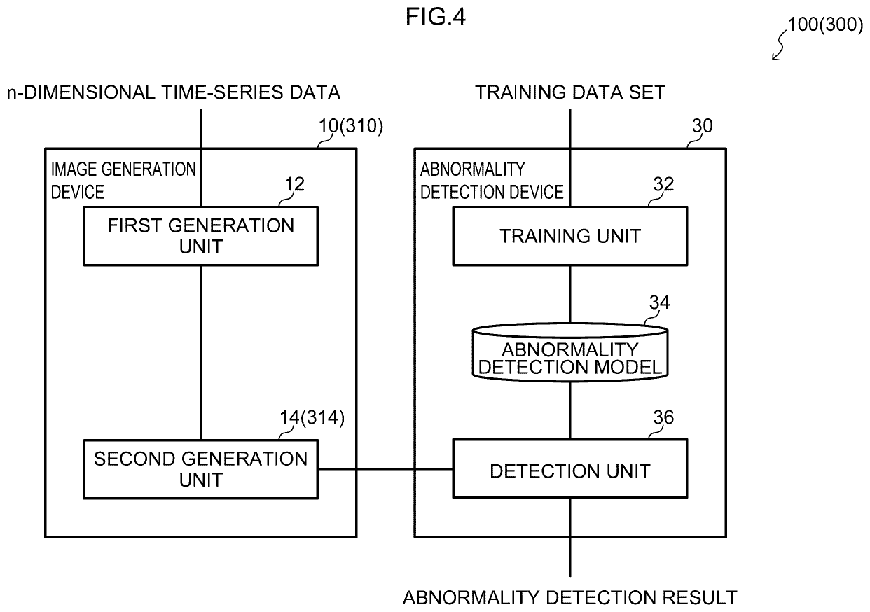

As illustrated in FIG. 4, an abnormality detection system 100 according to the first embodiment includes an image generation device 10 and an abnormality detection device 30. The image generation device 10 and the abnormality detection device 30 are connected via a network.

The n-dimensional time-series data is input to the image generation device 10, and the image generation device 10 generates a single image from the n-dimensional time-series data. n is an integer of 2 or more. The n-dimensional time-series data may be, for example, data detected at each time by each of n types of sensors. The abnormality detection device 30 detects an abnormality by using an image generated by the image generation device 10. The image generation device 10 functionally includes a first generation unit 12 and a second generation unit 14.

The first generation unit 12 generates a multi-dimensional first image representing a frequency characteristic at each time of each piece of time-series data based on each piece of n-dimensional time-series data input to the image generation device 10.

Specifically, the first generation unit 12 converts the n-dimensional time-series data into time-series data indicating a feature amount mapped to an n-dimensional principal component axis by principal component analysis in order to prevent duplication of information at the time of linear combination (details will be described later) of n-dimensional scalogram images. More specifically, the first generation unit 12 calculates eigenvectors and eigenvalues (contribution degree) by applying principal component analysis to a dimension direction of the n-dimensional time-series data. The first generation unit 12 performs orthogonalization using eigenvectors and converts each of n-dimensional principal component axes into time-series data (referred to as “n-dimensional principal component time-series data” below) having a feature amount at each time as a value. The feature amount obtained by mapping the n-dimensional time-series data to the n-dimensional principal component axis can also be said to be a numerical value obtained by linearly transforming the n-dimensional time-series data with an eigenvector matrix.

The first generation unit 12 performs wavelet transform on each piece of principal component time-series data of n-dimensional principal component time-series data to calculate a scalogram (time/frequency characteristic). The time-frequency analysis method is not limited to the wavelet transform as long as the method is a transform method capable of obtaining a sparse image, such as calculating a spectrum by performing short-time Fourier transform on each piece of principal component time-series data. Furthermore, the wavelet transform to be applied may be a complex Morley wavelet, a Ricker wavelet, or the like.

For example, the first generation unit 12 associates a column direction (horizontal direction) of the scalogram image with time and associates a row direction (vertical direction) of the scalogram image with the frequency. The first generation unit 12 embeds the intensity Sₖ(i,j) of the scalogram at the frequency j at the time i, which is calculated from the k-th dimensional principal component time-series data in a pixel position (i,j) of the scalogram image. The value to be embedded in the scalogram image may be a value Sₖ^{˜}(i,j) obtained by normalizing Sₖ(i,j) according to the following expression (1).

Sₖ^{˜}(i,j)=Sₖ(i,j)/max(|S_{k,min}|,|S_{k,max}|) (1)

S_{k,min} is the minimum value of Sₖ(i,j), and S_{k,max} is the maximum value of Sₖ(i,j). Depending on the type of the wavelet transform to be used, Sₖ(i,j) may be a negative value, and thus an absolute value is taken.

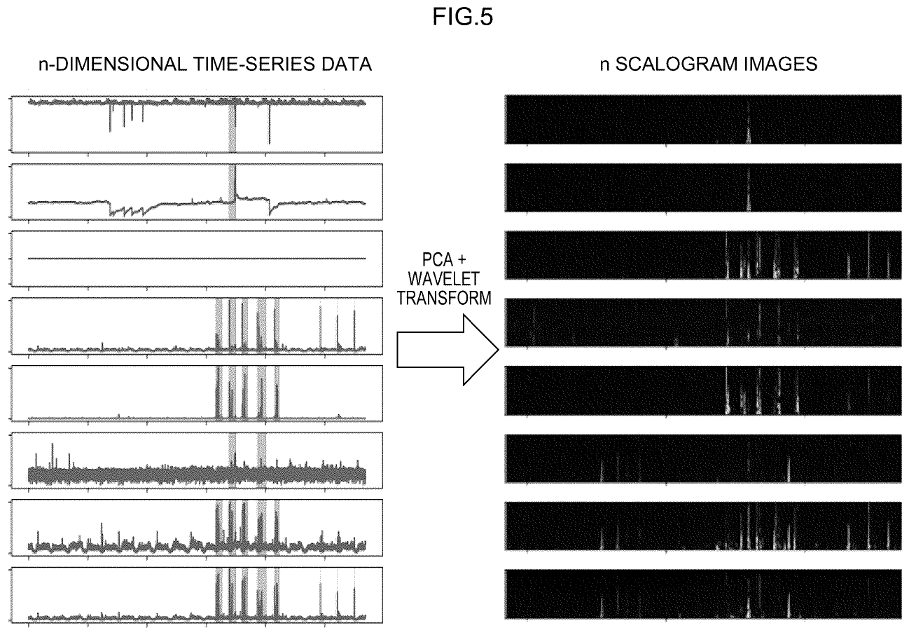

As a result, as illustrated in FIG. 5, n scalogram images are generated from the n-dimensional time-series data (in the example of FIG. 5, n=8). Note that the scalogram image is an example of a “first image” of the disclosed technique.

The first generation unit 12 may generate, for each piece of time-series data, two types of n scalogram images representing two different types of frequency characteristics. The two types of frequency characteristics may be, for example, a real part and an imaginary part of the complex Morley wavelet transform, or may be an absolute value of a complex Morley wavelet and a Ricker wavelet.

The second generation unit 14 generates a single image obtained by combining n scalogram images weighted using a random matrix in which a different value is assigned for each frequency.

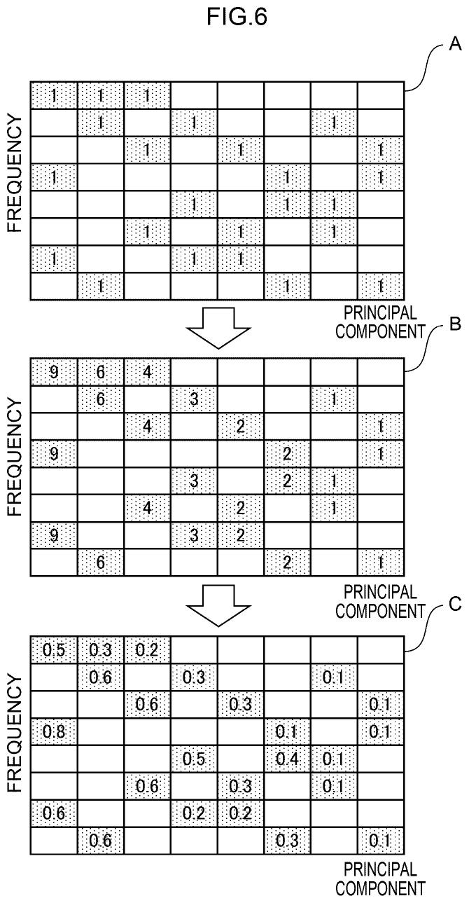

Specifically, the second generation unit 14 generates a random matrix for combining the scalogram image at each time based on the contribution degree obtained by the principal component analysis. For example, as illustrated in A of FIG. 6, the second generation unit 14 takes a weight 1 for m (m=3 in the example of FIG. 6) random principal components for each frequency, and creates a sparse matrix with a weight 0 for the remaining principal components. As illustrated in B of FIG. 6, the second generation unit 14 multiplies the sparse matrix by the contribution degree obtained by PCA for each principal component. As illustrated in C of FIG. 6, the second generation unit 14 normalizes the weight so that the sum of the elements at each frequency becomes 1.

The random matrix generation method is an example, and different generation methods may be adopted as long as the random matrices have different weights in the frequency direction. The second generation unit 14 may use the same random matrix in the time direction, or may use random matrices having different weights in the time direction as illustrated in FIG. 3. In the latter case, for each time, a random matrix may be generated by, for example, the above method.

The second generation unit 14 linearly combines n scalogram images weighted by the random matrix to generate a single combined scalogram image. When the first generation unit 12 generates two types of n scalogram images, two types of combined scalogram images are generated.

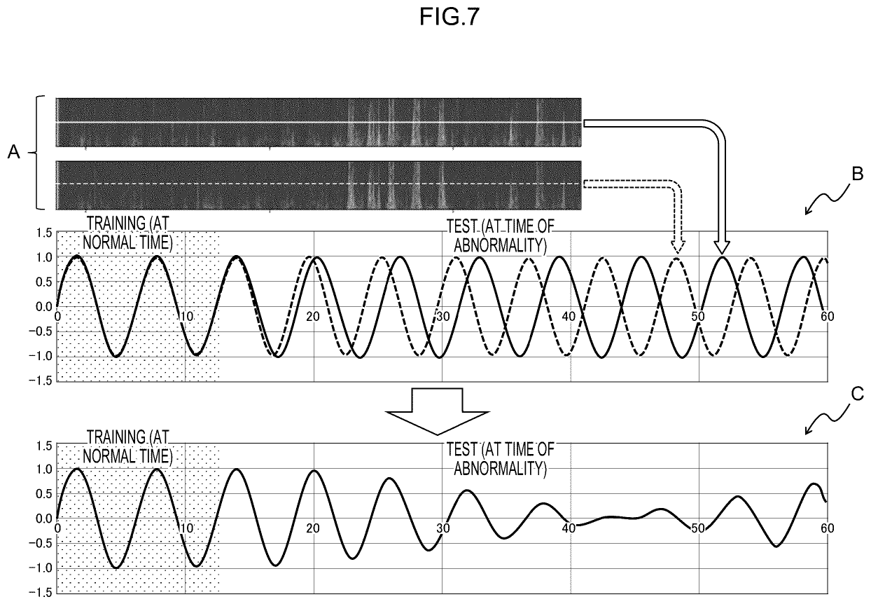

For example, it is assumed that a scalogram image is generated for each piece of two-dimensional time-series data as illustrated in A of FIG. 7. It is assumed that B of FIG. 7 is a waveform illustrating the temporal change of the intensity of the scalogram at the frequency corresponding to each of a solid line part and a broken line part of the scalogram image illustrated in A of FIG. 7. C of FIG. 7 is a waveform illustrating a variation of an average value of a solid line waveform and a broken line waveform in B of FIG. 7. As illustrated in B of FIG. 7, the two waveforms are substantially synchronized at the time of training (normal time). At the time of a test (at the time of abnormality), the cycles of the two waveforms slightly change from the middle. However, since a part of each scalogram image (waveform) has almost the same shape as that at the normal time, it is difficult to detect an abnormality from this waveform. By combining the two scalogram images (waveforms), as illustrated in C of FIG. 7, a waveform at the normal time is completely different from a waveform at the abnormal time, and thus it is possible to easily detect an abnormality.

However, in the case of handling m-dimensional time-series data, it is difficult to perform abnormality detection by combining two scalogram images (waveforms) at all frequencies for ₘC₂ combinations of all dimensions in terms of calculation amount. Depending on the combination of dimensions, the values are offset, and detection of an abnormality is not possible in some cases. As illustrated in FIG. 7, it is conceivable to select and combine any frequencies, but in this case, detection of an abnormality is not possible in some cases depending on the selected frequency.

Therefore, as in the present embodiment, m dimensions are randomly selected for each frequency by combining the scalogram image by weighting using a random matrix in which a different value is assigned for each frequency. Therefore, since various combinations of dimensions can be confirmed, there is a high possibility that the disturbance of the change in the correlation relationship between the dimensions can be detected. Since the same two-dimensional combination appears a plurality of times in the frequency direction, there is a high possibility that an abnormality can be detected at a certain frequency.

The second generation unit 14 may output the combined scalogram image as an image to be used for abnormality detection, but in the present embodiment, the second generation unit 14 generates an RGB image (referred to as a “single RGB image” below) as a single image. The combined scalogram image and the single RGB image are examples of a “second image” of the disclosed technique.

Specifically, the second generation unit 14 embeds the value of the combined scalogram image in a first component of an R component, a G component, and a B component of the RGB image in which the horizontal direction corresponds to the time direction and the vertical direction corresponds to the frequency direction. When two types of combined scalogram images are generated, the second generation unit 14 embeds a value of another type of combined scalogram image in a second component. Further, the second generation unit 14 sets different values in stages in accordance with the frequency, for example, sets a larger value as the frequency is higher, and embeds the set value in a third component.

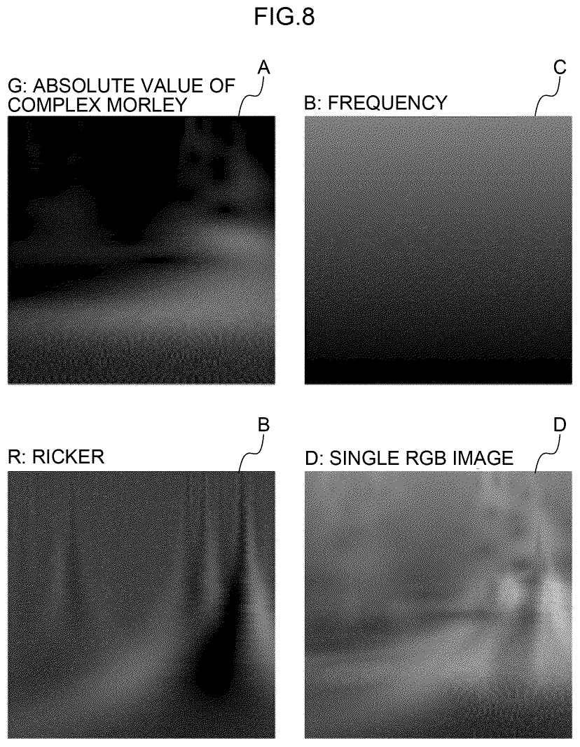

For example, it is assumed that two types of combined scalogram images of the absolute value of the complex Morley wavelet and the Ricker wavelet are generated. In this case, as illustrated in A of FIG. 8, the second generation unit 14 embeds the value of the combined scalogram image for the absolute value of the complex Morley wavelet in the G component. As illustrated in B of FIG. 8, the second generation unit 14 embeds the value of the combined scalogram image for the Ricker wavelet in the R component. As illustrated in C of FIG. 8, the second generation unit 14 embeds the value set in accordance with the frequency in the B component. As illustrated in D of FIG. 8, the second generation unit 14 combines the R component, the G component, and the B component in which the respective values are embedded to generate a single RGB image. In FIG. 8, for convenience of drawing, the image of each component and the RGB image are represented in gray scale.

When the combined scalogram image is generated by using the random matrix different also in the time direction, the second generation unit 14 embeds the value of the combined scalogram image in the first component among the R component, the G component, and the B component of the RGB image. The second generation unit 14 embeds different values in stages in accordance with the frequency in the second component. The second generation unit 14 sets different values in stages in accordance with the elapse of time, for example, sets a larger value as the elapse of time increases, and embeds the set value in the third component. For example, when the combined scalogram image for the absolute value of the complex Morley wavelet is generated, the second generation unit 14 embeds different values in stages in the R component illustrated in B of FIG. 8 in accordance with the elapse of time. In this case, the image of the B component in which the value corresponding to the frequency illustrated in C of FIG. 8 is embedded has a vertical gradation, whereas the image of the R component in which the value corresponding to the elapse of time is embedded has a horizontal gradation. The second generation unit 14 outputs the generated single RGB image to the abnormality detection device 30.

The abnormality detection device 30 functionally includes a training unit 32, an abnormality detection model 34, and a detection unit 36.

The training unit 32 acquires a training data set input to the abnormality detection device 30. Each piece of training data included in the training data set is a single RGB image generated based on n-dimensional time-series data at the normal time. The training unit 32 trains the abnormality detection model 34 by using the acquired training data set. The abnormality detection model 34 may be set as, for example, a machine learning model including a deep neural network or the like.

The detection unit 36 acquires a single RGB image generated by the image generation device 10 based on the n-dimensional time-series data as an abnormality detection target. The detection unit 36 inputs the acquired single RGB image to the abnormality detection model 34, and acquires and outputs an abnormality detection result output from the abnormality detection model 34.

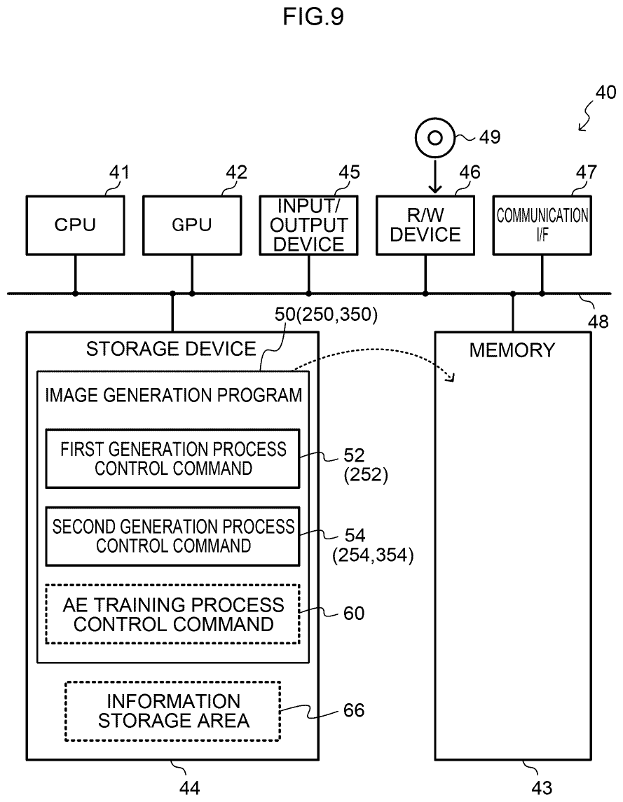

The image generation device 10 may be realized by, for example, a computer 40 illustrated in FIG. 9. The computer 40 includes a central processing unit (CPU) 41, a graphics processing unit (GPU) 42, a memory 43 as a temporary storage area and a nonvolatile storage device 44. The computer 40 includes an input/output device 45 such as an input device and a display device, and a read/write (R/W) device 46 that controls reading and writing of data with respect to a storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), a flash memory, or the like. The storage device 44 as a storage medium stores an image generation program 50 for causing the computer 40 to function as the image generation device 10. The image generation program 50 includes a first generation process control command 52 and a second generation process control command 54.

The CPU 41 reads the image generation program 50 from the storage device 44, loads the image generation program in the memory 43, and sequentially executes control commands included in the image generation program 50. The CPU 41 operates as the first generation unit 12 illustrated in FIG. 4 by executing the first generation process control command 52. In addition, the CPU 41 operates as the second generation unit 14 illustrated in FIG. 4 by executing the second generation process control command 54. As a result, the computer 40 that has executed the image generation program 50 functions as the image generation device 10. The CPU 41 that executes the program is hardware. A part of the program may be executed by the GPU 42.

Functions implemented by the image generation program 50 may be implemented by, for example, a semiconductor integrated circuit, more specifically, an application specific integrated circuit (ASIC), a field-programmable gate array (FPGA), or the like. The hardware configuration of the abnormality detection device 30 is substantially similar to the hardware configuration of the image generation device 10 illustrated in FIG. 9 except that the program stored in the storage device 44 is different, and thus a detailed description thereof will be omitted.

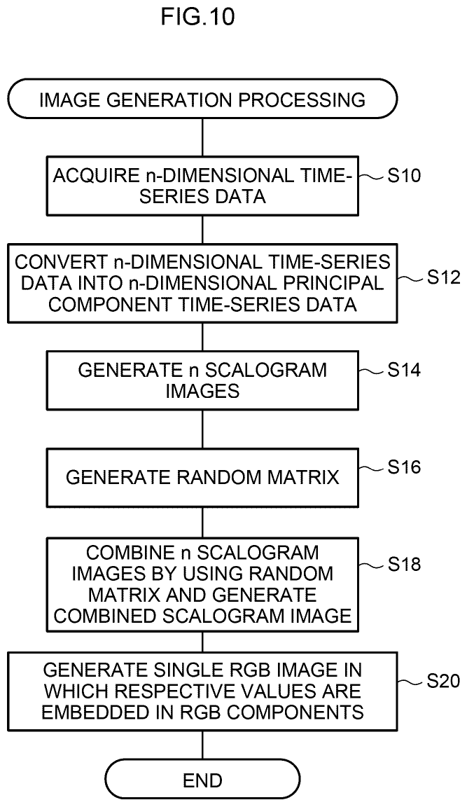

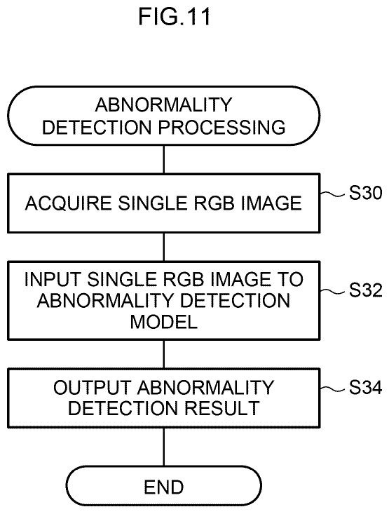

Next, the operation of the abnormality detection system 100 according to the first embodiment will be described. When n-dimensional time-series data is input to the image generation device 10 and generation of a single RGB image is instructed, the image generation device 10 executes image generation processing illustrated in FIG. 10. The image generation processing is an example of an image generation method of the disclosed technique. When the n-dimensional time-series data at the normal time is input and the image generation processing is executed, a single RGB image as training data for training the abnormality detection model 34 is generated. When a single RGB image as a plurality of pieces of training data is generated, the single RGB image is input to the abnormality detection device 30 as a training data set. The abnormality detection device 30 trains the abnormality detection model 34 by using the training data set. In a state where the trained abnormality detection model 34 is stored in the abnormality detection device 30, when a single RGB image generated based on n-dimensional time-series data as an abnormality detection target is input to the abnormality detection device 30, the abnormality detection device 30 executes abnormality detection processing illustrated in FIG. 11. Each of the image generation processing and the abnormality detection processing will be described below in detail.

First, the image generation processing illustrated in FIG. 10 will be described.

In Step S10, the first generation unit 12 acquires n-dimensional time-series data input to the image generation device 10. Then, in Step S12, the first generation unit 12 converts the n-dimensional time-series data into n-dimensional principal component time-series data by principal component analysis.

In Step S14, the first generation unit 12 performs wavelet transform on each piece of principal component time-series data of n-dimensional principal component time-series data and calculates a scalogram. The first generation unit 12 calculates a value Sₖ(i,j) obtained by normalizing the intensity Sₖ(i,j) of a scalogram at the frequency j at the time i, which is calculated from the k-th dimensional principal component time-series data, based on the maximum value and the minimum value of the k-th dimensional Sₖ(i,j). The first generation unit 12 generates a scalogram image for the k-th (k=1, 2, . . . , n) dimension by embedding Sₖ^{˜}(i,j) in a pixel position (i,j) of an image in which the horizontal direction corresponds to the time direction and the vertical direction corresponds to the frequency direction. As a result, n scalogram images are generated.

Then, in Step S16, the second generation unit 14 generates a random matrix in which a different value is assigned for each frequency based on the contribution degree obtained by the principal component analysis. Then, in Step S18, the second generation unit 14 linearly combines n scalogram images weighted by the random matrix to generate a single combined scalogram image.

Then, in Step S20, the second generation unit 14 embeds the value of the combined scalogram image in the first component of the R component, the G component, and the B component of the RGB image in which the horizontal direction corresponds to the time direction and the vertical direction corresponds to the frequency direction, and embeds different values in stages in accordance with the frequency, in the second component. When two types of combined scalogram images are generated, the second generation unit 14 embeds values of another type of combined scalogram image in the remaining components. Alternatively, the second generation unit 14 embeds different values in stages in the remaining components in accordance with the elapse of time. The second generation unit 14 combines the R component, the G component, and the B component in which the respective values are embedded, to generate and output a single RGB image, and the image generation processing ends.

Next, the abnormality detection processing illustrated in FIG. 11 will be described.

In Step S30, the detection unit 36 acquires a single RGB image as an abnormality detection target from the image generation device 10. Then, in Step S32, the detection unit 36 inputs the acquired single RGB image to the abnormality detection model 34. Then, in Step S34, the detection unit 36 acquires and outputs the abnormality detection result output from the abnormality detection model 34, and the abnormality detection processing ends.

As described above, according to the abnormality detection system according to the first embodiment, the image generation device generates the multi-dimensional first image representing the frequency characteristic at each time of each piece of time-series data based on each piece of multi-dimensional time-series data. The image generation device generates a single second image obtained by combining the multi-dimensional first images weighted using the random matrix in which a different value is assigned for each frequency. As a result, it is possible to generate an image in which an abnormality appearing as a change in a correlation relationship between a plurality of dimensions can be detected, from multi-dimensional time-series data. As a result, it is possible to create an abnormality detection model for any piece of multi-dimensional time-series data in a short time by applying an image classifier which is a base model.

### Second Embodiment

Next, a second embodiment will be described. In an abnormality detection system according to the second embodiment, the same reference signs are given to the same components as those of the abnormality detection system 100 according to the first embodiment, and reference signs having common last two digits are given to components having common functions, and a detailed description thereof will be omitted.

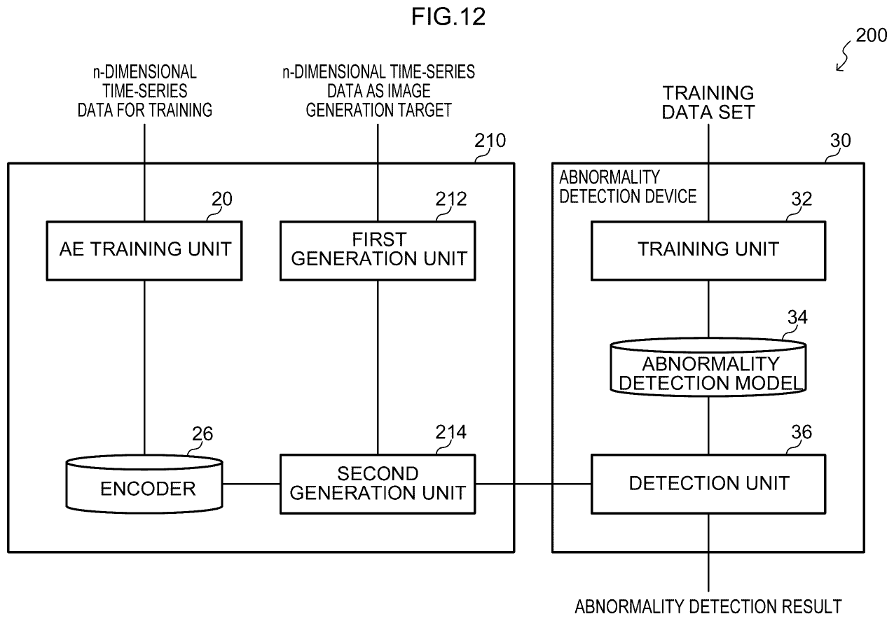

As illustrated in FIG. 12, an abnormality detection system 200 according to the second embodiment includes an image generation device 210 and an abnormality detection device 30. The image generation device 210 and the abnormality detection device 30 are connected via a network.

The image generation device 210 functionally includes an AE training unit 20, a first generation unit 212 and a second generation unit 214. An encoder 26 is stored in a predetermined storage area of the image generation device 210.

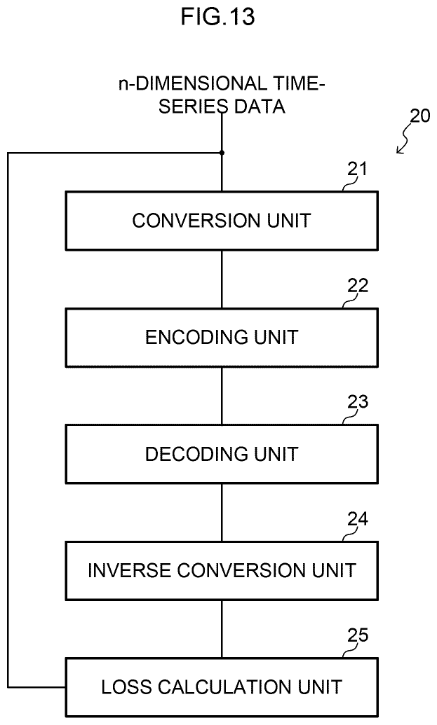

More specifically, as illustrated in FIG. 13, the AE training unit 20 includes, as functional units, a conversion unit 21, an encoding unit 22, a decoding unit 23, an inverse conversion unit 24, and a loss calculation unit 25.

The conversion unit 21 acquires n-dimensional time-series data for training, which is input to the image generation device 210. The conversion unit 21 performs wavelet transform on each piece of time-series data of the n-dimensional time-series data and generates a scalogram image. A scalogram image generation method is similar to the processing of generating n scalogram images from n-dimensional principal component time-series data by the first generation unit 12 in the first embodiment. Instead of the wavelet transform, another transform method capable of inverse transform such as Fourier transform may be used.

The encoding unit 22 is an encoder configured by a neural network. The decoding unit 23 is a decoder configured by a neural network. The encoding unit 22 and the decoding unit 23 constitute an auto encoder (AE). The encoding unit 22 converts n scalogram images generated by the conversion unit 21 into a single RGB image. The decoding unit 23 restores the single RGB image converted by the encoding unit 22 to n restoration scalogram images.

The inverse conversion unit 24 applies an inverse wavelet transform to each restoration scalogram image of the n restoration scalogram images to convert the restoration scalogram image into n-dimensional restoration time-series data.

The loss calculation unit 25 calculates a loss between the input n-dimensional time-series data and the n-dimensional restoration time-series data converted by the inverse conversion unit 24. For example, the loss calculation unit 25 calculates, as a loss, an error between each piece of time-series data and the restoration time-series data corresponding to the time-series data. The error may be, for example, a square error between a waveform indicating the time-series data and a waveform indicating the restoration time-series data.

The loss calculation unit 25 updates parameters of the encoder and the decoder to minimize the calculated loss. The loss calculation unit 25 repeatedly executes the processing of the conversion unit 21, the encoding unit 22, the decoding unit 23, and the inverse conversion unit 24 until the loss is minimized. The loss calculation unit 25 may determine that the loss is minimized, for example, when the number of repetitions of the processing exceeds a predetermined number, when the loss is equal to or less than a predetermined value, when a difference between the loss calculated previously and the loss calculated this time is equal to or less than a predetermined value, or the like. The loss calculation unit 25 extracts the encoder 26 when the loss is minimized, and stores the encoder in a predetermined storage area.

That is, the AE training unit 20 executes training of a machine learning model having a configuration in which an AE is sandwiched between the conversion unit 21 and the inverse conversion unit 24, thereby generating an encoder for converting n scalogram images into a single RGB image.

The first generation unit 212 acquires n-dimensional time-series data as an image generation target input to the image generation device 210. The first generation unit 212 is similar to the first generation unit 212 in the first embodiment except that n scalogram images are generated without converting the n-dimensional time-series data into the n-dimensional principal component time-series data.

The second generation unit 214 generates a single RGB image by inputting the n scalogram images generated by the first generation unit 212 to the trained encoder 26.

The image generation device 210 may be realized by, for example, the computer 40 illustrated in FIG. 9. The storage device 44 of the computer 40 stores an image generation program 250 for causing the computer 40 to function as the image generation device 210. The image generation program 250 has an AE training process control command 60, a first generation process control command 252, and a second generation process control command 254. The storage device 44 has an information storage area 66 in which information constituting the encoder 26 is stored.

The CPU 41 reads the image generation program 250 from the storage device 44, loads the image generation program in the memory 43, and sequentially executes control commands included in the image generation program 250. The CPU 41 operates as the AE training unit 20 illustrated in FIG. 12 by executing the AE training process control command 60. The CPU 41 operates as the first generation unit 212 illustrated in FIG. 12 by executing the first generation process control command 252. The CPU 41 operates as the second generation unit 214 illustrated in FIG. 12 by executing the second generation process control command 254. The CPU 41 reads information from the information storage area 66 and loads the encoder 26 in the memory 43. As a result, the computer 40 that has executed the image generation program 250 functions as the image generation device 210. The CPU 41 that executes the program is hardware. A part of the program may be executed by the GPU 42.

The functions implemented by the image generation program 250 may be implemented by, for example, a semiconductor integrated circuit, more specifically, an ASIC, an FPGA, or the like.

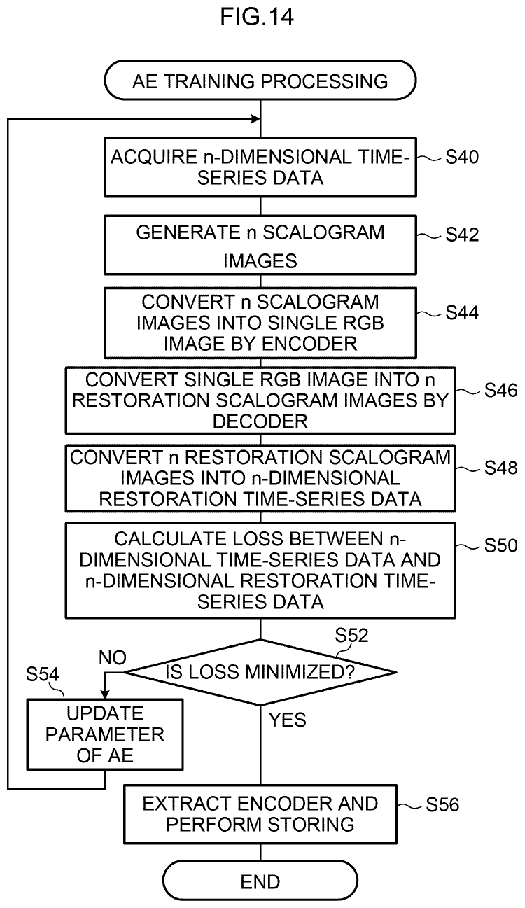

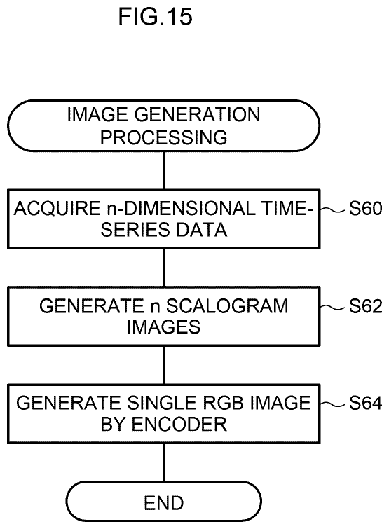

Next, the operation of the abnormality detection system 200 according to the second embodiment will be described. When the n-dimensional time-series data for training is input to the image generation device 210 and training of the encoder is instructed, the image generation device 210 executes AE training processing illustrated in FIG. 14. In a state where the trained encoder 26 is stored in the image generation device 210, when n-dimensional time-series data as an image generation target is input to the image generation device 210 and generation of a single RGB image is instructed, the image generation device 210 executes image generation processing illustrated in FIG. 15. The operation of the abnormality detection device 30 is similar to that of the first embodiment. Each of the AE training processing and the image generation processing will be described below in detail.

First, the AE training processing illustrated in FIG. 14 will be described.

In Step S40, the conversion unit 21 acquires the n-dimensional time-series data for training, which is input to the image generation device 210. Then, in Step S42, the conversion unit 21 performs wavelet transform on each piece of time-series data of the n-dimensional time-series data and generates a scalogram image. Then, in Step S44, the encoding unit 22 converts the n scalogram images into a single RGB image.

Then, in Step S46, the decoding unit 23 restores the single RGB image to n restoration scalogram images by the decoder. Then, in Step S48, the inverse conversion unit 24 applies an inverse wavelet transform to each restoration scalogram image of the n restoration scalogram images to convert the restoration scalogram image into n-dimensional restoration time-series data.

Then, in Step S50, the loss calculation unit 25 calculates a loss between the n-dimensional time-series data acquired in Step S40 and the n-dimensional restoration time-series data converted in Step S48. Then, in Step S52, the loss calculation unit 25 determines whether or not the loss has been minimized. When the loss is minimized, the process proceeds to Step S56. When the loss is not minimized, the process proceeds to Step S54. In Step S54, the loss calculation unit 25 updates the parameters of the encoder and the decoder to minimize the loss, and the process returns to Step S40. In Step S56, the loss calculation unit 25 extracts the encoder 26 when the loss is minimized, and stores the encoder in a predetermined storage area. Then, the AE training processing ends.

Next, image generation processing in the second embodiment will be described with reference to FIG. 15.

In Step S60, the first generation unit 212 acquires n-dimensional time-series data as the image generation target, which is input to the image generation device 210. Then, in Step S62, the first generation unit 212 generates n scalogram images from the n-dimensional time-series data. Then, in Step S64, the second generation unit 214 generates and outputs a single RGB image by inputting n scalogram image to the trained encoder 26, and the image generation processing ends.

As described above, according to the abnormality detection system according to the second embodiment, the image generation device generates the multi-dimensional first image representing the frequency characteristic at each time of each piece of time-series data based on each piece of multi-dimensional time-series data. The image generation device generates the encoder by training the self-encoder to convert the multi-dimensional first image into a single image by using the multi-dimensional first image as training data. The image generation device inputs the generated multi-dimensional first image to the encoder, thereby generating a single second image obtained by combining the multi-dimensional first images. As a result, it is possible to generate an image in which an abnormality appearing as a change in a correlation relationship between a plurality of dimensions can be detected, from multi-dimensional time-series data. As a result, it is possible to create an abnormality detection model for any piece of multi-dimensional time-series data in a short time by applying an image classifier which is a base model.

In the second embodiment, similarly to the first embodiment, the scalogram image may be generated after the n-dimensional time-series data is converted into the n-dimensional principal component time-series data. In this case, an orthogonalization unit that converts the n-dimensional time-series data into the n-dimensional principal component time-series data may be inserted before the conversion unit 21, and a restoration unit that converts the n-dimensional principal component time-series data into the n-dimensional time-series data may be inserted after the inverse conversion unit 24.

In the first and second embodiments, a case where a single RGB image is generated from n-dimensional time-series data as an image to be input to the abnormality detection model has been described, but the present embodiments are not limited thereto. Even in the case of a one-component grayscale image showing a combined scalogram image, the same effects as those of the above embodiments can be obtained.

### Third Embodiment

Next, a third embodiment will be described. In an abnormality detection system according to the third embodiment, the same reference signs are given to the same components as those of the abnormality detection system 100 according to the first embodiment, and reference signs having common last two digits are given to components having common functions, and a detailed description thereof will be omitted.

As illustrated in FIG. 4, an abnormality detection system 300 according to the third embodiment includes an image generation device 310 and an abnormality detection device 30. The image generation device 310 and the abnormality detection device 30 are connected via a network.

The image generation device 310 functionally includes a first generation unit 12 and a second generation unit 314. The first generation unit 12 is similar to that of the first embodiment, but in the third embodiment, it is essential to generate a plurality of types of scalogram images representing different frequency characteristics. The first generation unit 12 generates, for example, a scalogram image for each of the real part and the imaginary part of the complex Morley wavelet transform. The first generation unit 12 may generate, for example, a scalogram image for each of the absolute value of the complex Morley wavelet and the Ricker wavelet. The first generation unit 12 may generate three types of scalogram images.

The second generation unit 314 generates a single RGB image obtained by combining a plurality of types of n scalogram images. Specifically, the second generation unit 314 embeds the value of each type of the combined scalogram image in each component of the R component, the G component, and the B component of the RGB image in which the horizontal direction corresponds to the time direction and the vertical direction corresponds to the frequency direction. When there are two types of scalogram images, the second generation unit 314 may embed different values in stages in accordance with the frequency or different values in stages in accordance with the elapse of time, in the remaining components.

The second generation unit 314 combines the R component, the G component, and the B component in which the respective values are embedded, generates a single RGB image, and outputs the generated single RGB image to the abnormality detection device 30.

The image generation device 310 may be realized by, for example, the computer 40 illustrated in FIG. 9. The storage device 44 of the computer 40 stores an image generation program 350 for causing the computer 40 to function as the image generation device 310. The image generation program 350 includes a first generation process control command 52 and a second generation process control command 354.

The CPU 41 reads the image generation program 350 from the storage device 44, loads the image generation program in the memory 43, and sequentially executes control commands included in the image generation program 350. The CPU 41 operates as the first generation unit 12 illustrated in FIG. 4 by executing the first generation process control command 52. The CPU 41 operates as the second generation unit 314 illustrated in FIG. 4 by executing the second generation process control command 354. As a result, the computer 40 that has executed the image generation program 350 functions as the image generation device 310. The CPU 41 that executes the program is hardware. A part of the program may be executed by the GPU 42.

The functions implemented by the image generation program 350 may be implemented by, for example, a semiconductor integrated circuit, more specifically, an ASIC, an FPGA, or the like.

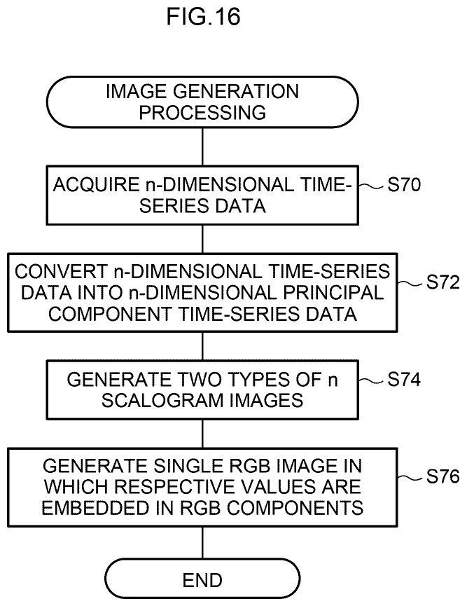

Next, the operation of the abnormality detection system 300 according to the third embodiment will be described. When n-dimensional time-series data is input to the image generation device 310 and generation of a single RGB image is instructed, the image generation device 310 executes image generation processing illustrated in FIG. 16. The operation of the abnormality detection device 30 is similar to that of the first embodiment. Image generation processing in the third embodiment will be described below in detail.

In Step S70, the first generation unit 12 acquires n-dimensional time-series data input to the image generation device 10. Then, in Step S72, the first generation unit 12 converts the n-dimensional time-series data into n-dimensional principal component time-series data by principal component analysis.

In Step S74, the first generation unit 12 performs wavelet transform on each piece of principal component time-series data of n-dimensional principal component time-series data and generates a scalogram. At this time, the first generation unit 12 generates two types of scalogram images representing two different types of frequency characteristics.

Then, in Step S76, the second generation unit 314 embeds the value of the combined scalogram image of the first type in the first component of the R component, the G component, and the B component of the RGB image in which the horizontal direction corresponds to the time direction and the vertical direction corresponds to the frequency direction. In addition, the second generation unit 314 embeds the value of the combined scalogram image of the second type in the second component. In addition, the second generation unit 314 embeds different values in stages in accordance with the frequency or different values in stages in accordance with the elapse of time in the third component. The second generation unit 314 combines the R component, the G component, and the B component in which the respective values are embedded, to generate and output a single RGB image, and the image generation processing ends.

As described above, according to the abnormality detection system according to the third embodiment, the image generation device generates a plurality of types of the multi-dimensional first image representing a plurality of types of different frequency characteristics at each time of each piece of time-series data based on each piece of multi-dimensional time-series data. The image generation device generates a single second image obtained by combining a plurality of types of multi-dimensional first images. As a result, it is possible to generate an image allowing improvement in the accuracy of abnormality detection by an image in which images generated from each piece of time-series data are singly arranged, PCA, AE, or the like, as compared with a case where multi-dimensional time-series data is compressed into one-dimensional time-series data and then imaged. In addition, it is possible to create an abnormality detection model for any piece of multi-dimensional time-series data in a short time by applying an image classifier which is a base model.

In the first and third embodiments, the processing of converting the n-dimensional time-series data into the n-dimensional principal component time-series data is not essential.

In each of the above embodiments, the image generation program is stored (installed) in the storage device in advance, but the present embodiment is not limited thereto. The program according to the disclosed technique may be provided in a form stored in a storage medium such as a CD-ROM, a DVD-ROM, or a USB memory.

In many cases, the time-series data is multi-dimensional data acquired by each of a plurality of sensors, and in order to realize highly accurate abnormality detection, it is desirable to image the time-series data in consideration of the correlation relationship between dimensions. However, in an image in which time-series data of each dimension is individually imaged and arranged, in some cases, detection of an abnormality appearing as the change in the correlation relationship between a plurality of dimensions is not possible. In addition, in the signal processing method described above, two pieces of time-series data are mainly assumed, and it is not possible to consider the correlation relationship between any dimensions in high-dimensional data.

According to the disclosed technique, it is possible to generate an image in which an abnormality appearing as a change in a correlation relationship between a plurality of dimensions can be detected, from multi-dimensional time-series data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program that causes a computer to execute image generation processing comprising:
generating a multi-dimensional first image representing a frequency characteristic at each time of each piece of time-series data, based on each piece of multi-dimensional time-series data; and
generating a single second image obtained by combining the multi-dimensional first images weighted using a random matrix in which a different value is assigned for each frequency.

2. The non-transitory recording medium of claim 1, wherein:
in the generating of the multi-dimensional first image, the multi-dimensional time-series data is converted into time-series data indicating a feature amount mapped onto a multi-dimensional principal component axis by principal component analysis, and the multi-dimensional first image is generated based on the converted time-series data.

3. The non-transitory recording medium of claim 2, wherein:
the random matrix is a matrix using, as an element, a value obtained in a manner that a sparse matrix, in which a weight for predetermined pieces of first images randomly selected among the multi-dimensional first images is set as 1 and a weight for other first images is set as 0, is multiplied by a contribution degree obtained by the principal component analysis, at each frequency, and a value after multiplication is normalized for each frequency.

4. The non-transitory recording medium of claim 1, wherein:
the generating of the second image includes performing weighting on the multi-dimensional first image by using a different random matrix at each time.

5. The non-transitory recording medium of claim 4, wherein:
the generating of the second image includes embedding a weighted value for the multi-dimensional first image in a first component among an R component, a G component, and a B component of an RGB image, embedding, in a second component, different values in stages in accordance with a frequency, and embedding, in a third component, different values in stages in accordance with elapse of time.

6. The non-transitory recording medium of claim 1, wherein:
the generating of the multi-dimensional first image includes generating two types of the multi-dimensional first images representing two different types of frequency characteristics for each piece of time-series data, and
the generating of the second image includes embedding a weighted value for a first type of multi-dimensional first image in a first component among an R component, a G component, and a B component of an RGB image, embedding, in a second component, a weighted value for a second type of multi-dimensional first image, and embedding, in a third component, different values in stages in accordance with a frequency.

7. The non-transitory recording medium of claim 6, wherein:
the two types of frequency characteristics are set as a real part and an imaginary part of complex Morley wavelet transform, or set as an absolute value of a complex Morley wavelet and a Ricker wavelet.

8. A non-transitory recording medium storing a program that causes a computer to execute image generation processing comprising:
generating a multi-dimensional first image representing a frequency characteristic at each time of each piece of time-series data, based on each piece of multi-dimensional time-series data; and
generating a single second image obtained by combining the multi-dimensional first images in a manner that the generated multi-dimensional first image is input to an encoder obtained by training a self-encoder to convert the multi-dimensional first image into a single image by using the multi-dimensional first image as training data.

9. The non-transitory recording medium of claim 8, wherein:
the encoder is the encoder in the self-encoder trained to convert a multi-dimensional restoration image of the multi-dimensional first image obtained by inputting the multi-dimensional first image obtained by converting the multi-dimensional time-series data to the self-encoder, which includes an encoder and a decoder, into multi-dimensional restoration time-series data, and to minimize an error between the multi-dimensional time-series data and the multi-dimensional restoration time-series data.

10. A non-transitory recording medium storing a program that causes a computer to execute image generation processing comprising:
generating a plurality of types of multi-dimensional first images representing a plurality of types of different frequency characteristics at each time of each piece of time-series data, based on each piece of multi-dimensional time-series data; and
generating a single second image obtained by combining the plurality of types of multi-dimensional first images.

11. An image generation method, comprising:
by a processor,
generating a multi-dimensional first image representing a frequency characteristic at each time of each piece of time-series data, based on each piece of multi-dimensional time-series data; and
generating a single second image obtained by combining the multi-dimensional first images weighted using a random matrix in which a different value is assigned for each frequency.

12. The image generation method of claim 11, wherein:
the generating of the multi-dimensional first image includes converting the multi-dimensional time-series data into time-series data indicating a feature amount mapped onto a multi-dimensional principal component axis by principal component analysis, and generating the multi-dimensional first image based on the converted time-series data.

13. The image generation method of claim 12, wherein:
the random matrix is a matrix using, as an element, a value obtained in a manner that a sparse matrix, in which a weight for predetermined pieces of first images randomly selected among the multi-dimensional first images is set as 1 and a weight for other first images is set as 0, is multiplied by a contribution degree obtained by the principal component analysis, at each frequency, and a value after multiplication is normalized for each frequency.

14. The image generation method of claim 11, wherein:
the generating of the second image includes performing weighting on the multi-dimensional first image by using a different random matrix at each time.

15. The image generation method of claim 14, wherein:
the generating of the second image includes embedding a weighted value for the multi-dimensional first image in a first component among an R component, a G component, and a B component of an RGB image, embedding, in a second component, different values in stages in accordance with a frequency, and embedding, in a third component, different values in stages in accordance with elapse of time.

16. The image generation method of claim 11, wherein:
the generating of the multi-dimensional first image includes generating two types of the multi-dimensional first images representing two different types of frequency characteristics for each piece of time-series data, and
the generating of the second image includes embedding a weighted value for a first type of multi-dimensional first image in a first component among an R component, a G component, and a B component of an RGB image, embedding, in a second component, a weighted value for a second type of multi-dimensional first image, and embedding, in a third component, different values in stages in accordance with a frequency.
